(19) United States
(12) Patent Application Publication
(10) Pub. No.: US 2014/0155690 A1
(43) Pub. Date: Jun. 5, 2014

(54) Touchscreen Cunnilingus Training Simulator

(71) Applicant: Ralph Clinton Morton, Grass Valley, CA (US)

(72) Inventor: Ralph Clinton Morton, Grass Valley, CA (US)

(21) Appl. No.: 14/097,242

(22) Filed: Dec. 5, 2013

Related U.S. Application Data
(60) Provisional application No. 61/733,827, filed on Dec. 5, 2012.

(51) Int. Cl. G09B 9/00; G09B 5/06; A63F 13/90; A61H 19/00; A63F 13/30

(52) U.S. Cl. CPC G09B 9/00; A61H 19/00; A63F 13/12; A63F 13/08; G09B 5/06
USPC 600/38; 434/257

(57) ABSTRACT

A device and method are provided for simulating cunnilingus by means of a touchscreen device, for training or entertainment purposes. A conductive overlay is provided to add a tactile reference for the user.

### CROSS-REFERENCE TO RELATED APPLICATIONS

The present application claims the benefit of U.S. Provisional Patent Application No. 61/733,827, filed Dec. 5, 2012, which is hereby incorporated by reference in its entirety.

### BACKGROUND OF THE INVENTION

1. Field of the Invention

The present invention relates to sexual training and simulation devices, and in particular to a software program for a touchscreen device and a conductive overlay for the touchscreen device that simulates cunnilingus.

2. Description of the Prior Art

The background description provided herein is for the purpose of generally presenting the context of the disclosure. Unless otherwise indicated herein, the materials described in this section are not prior art to the claims in this application and are not admitted to be prior art by inclusion in this section.

The art of cunnilingus is a difficult one to learn, and training devices are helpful in assisting aspiring lovers in perfecting their technique. Also, many people find giving oral sex to a woman to be sexually exciting and may find a simulation of that nature to be entertaining. However, there are not too many devices on the market that simulate oral sex for the giver (rather than for the receiver) in a way that can train him or her to improve at this skill.

Since a smartphone or tablet screen may be operated with a tongue as well as a finger, and since smartphones are so ubiquitous, it makes it an ideal candidate for an oral sex training device. However, since the smartphone screen is smooth glass, and a user cannot see it while touching it with their tongue, an extra tactile reference may also be required for the user.

### SUMMARY OF THE INVENTION

An object of the present invention is to provide a simulation of cunnilingus for a user by means of a touchscreen device.

Another object of the present invention is to provide a conductive overlay for a touchscreen to give the user a tactile reference while engaging in simulated cunnilingus.

Another object of the present invention is to provide an arcade game that measures and evaluates the user's cunnilingus skills.

The preferred embodiment of the present invention comprises a conductive overlay for a touchscreen shaped like the external female genitalia, and a touchscreen-enabled programmable device such as a smartphone or tablet computer that is programmed to interpret the user's contact with the touchscreen or the conductive overlay and provide the user with feedback and instructions. In an alternate embodiment, a touchpad connected to a computer may be used in place of a touchscreen-enabled programmable device.

A method of the present invention comprises placing a conductive overlay over a touchscreen of a mobile device, displaying an image of the female genitalia on the touchscreen, and providing the user with feedback based on how they touch the touchscreen. The user may also be provided with instructions on how to touch the touchscreen, sexual fantasies to make the experience more interesting, and an evaluation of their performance.

The instructions may continue throughout the user's session and may depend on the user's actions. For example, a user who has performed a particular gesture several times in a row may be instructed to do something different, to pause for a while, or to increase or decrease the rate or pressure of stimulation. The instructions may also be customizable and downloadable; the user may be able to download a guided oral sex experience customized for a particular simulated woman, or for a real woman.

The simulated sexual response may be customized by the user, the user's partner, or another party (such as a sex educator or therapist) to respond in particular ways to particular types of stimulation. Also, the sexual fantasies, instructions, and feedback may also be customized, created, and shared via social networking or the Internet in general.

The simulated sexual response, instructions, fantasies, and any other responses may be visual, auditory, tactile (i.e. using the vibrate function of the phone), or any combination of the above.

The conductive overlay is preferably made of silicone rubber, PET (polyethylene terephthalate), tempered glass, or any other conductive material that does not prevent the touchscreen from functioning. It may cover the whole touchscreen, or part of the touchscreen; multiple conductive elements may also be used. The conductive overlay may be a detailed model of the female genitalia, or a simple nubbin to indicate the clitoris.

### LIST OF FIGURES

FIG. 1 shows a front and side view of a smartphone with a conductive overlay showing a 3D clitoris.

FIG. 2 shows a front and side view of a smartphone with a conductive overlay showing a 3D vulva.

FIG. 3 shows a diagram of the method of the present invention.

FIG. 4 shows a sample instructional set for the method of the present invention.

FIG. 5 shows a sample interface for an arcade game embodiment of the invention.

FIG. 6 shows another sample arcade game embodiment of the invention.

### DETAILED DESCRIPTION OF THE PREFERRED EMBODIMENT

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase at least one of A, B and C″ means “(A), (B), (C), (A and B), (A and C), (B and C) or (A, B and C)”.

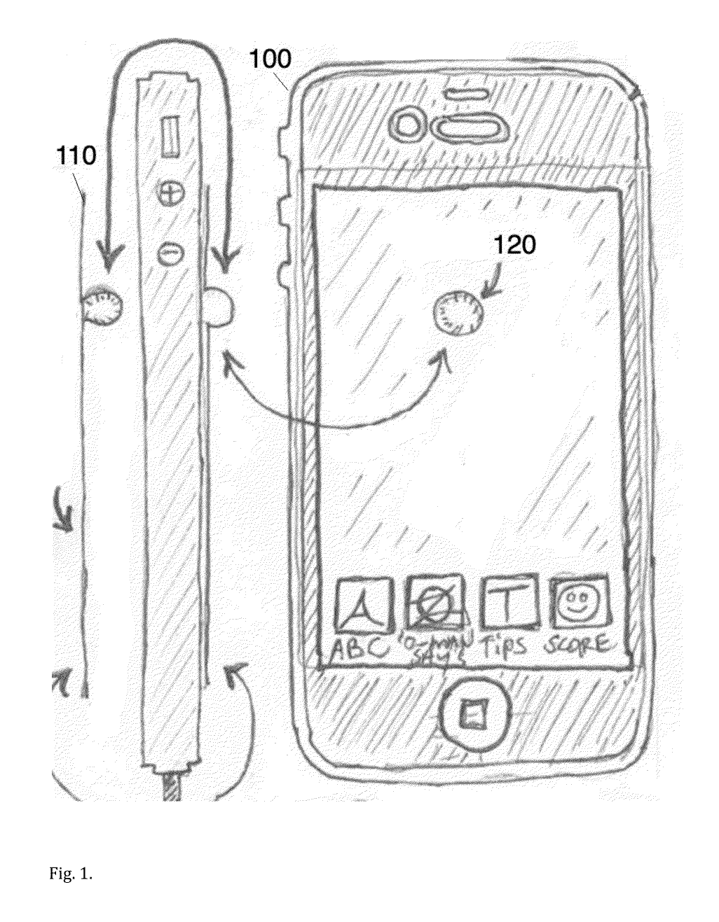

FIG. 1 shows a view of one preferred embodiment of the device of the present invention. Smartphone 100 is provided with an app that displays an image of the female genitalia on the screen. An overlay 110, comprising a nubbin 120 at the location of the clitoris, is adhered to the screen with removable adhesive. The overlay 110 is preferably made of PET (polyethylene terephthalate), but may also be made of silicone rubber, tempered glass, or any other material that is conductive, waterproof, and durable enough for such use. The user touches the image of the female genitalia with his or her tongue, using the nubbin 120 as a tactile reference, and the device provides a simulated sexual response.

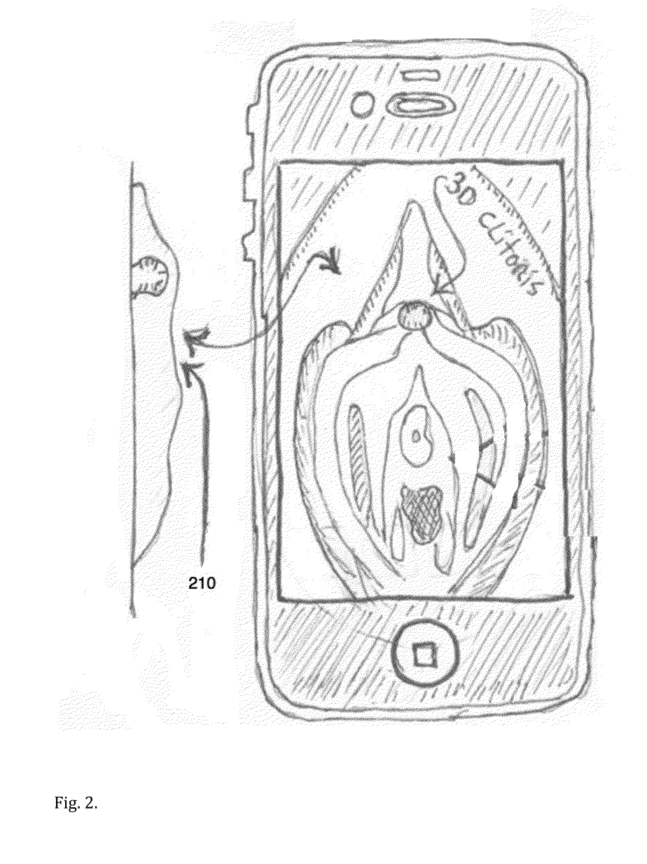

FIG. 2 shows an alternate embodiment of the device of the present invention, where the overlay 210 is more complex and comprises a realistic or fantasy model of the external female genitalia. This provides a better tactile reference for the user, and better training.

In an alternate embodiment (not shown), multiple conductive elements are adhered to the screen, leaving some other portions of the screen uncovered. The user can then customize the location and type of those conductive elements.

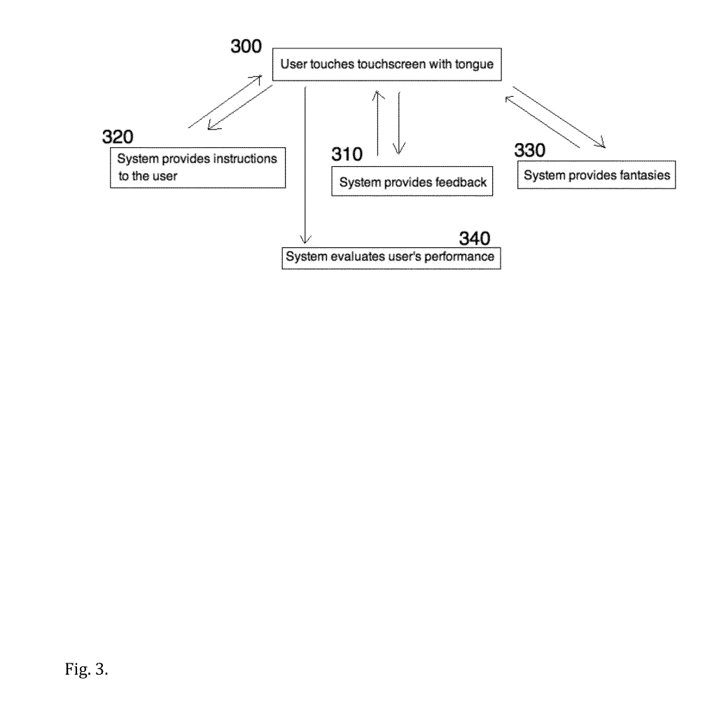

FIG. 3 shows an embodiment of the method of the present invention. The user touches the touchscreen with their tongue 300. The system provides feedback 310. Said feedback is preferably auditory, but can also be visual or tactile, and is designed to simulate the female sexual response. For example, visual feedback can be patterns that appear on the screen on or around the image of the external female genitalia, displaying signs of sexual excitement, changing color, blinking, or reacting in some other way to the user's contact with the touch screen. Auditory feedback can be recordings of moaning, panting, or other sounds of sexual excitement, or can be verbal (screaming the user's name, for example). Tactile feedback may use the mobile device's vibrate function.

The system can also provide instructions to the user 320 on what to do to maximize the simulated sexual excitement. Said instructions can be verbal or visual prompts.

Verbal prompts can be explicit instructions such as “Softly suck on the clitoris”, encouragements such as “Oh yes!” or “Ooooh don't stop!”, or corrections such as “Faster” or “Slower”. Visual prompts can be graphical shapes displayed on the screen that indicate a path for the user's tongue to follow—for example, the user can be directed to move his or her tongue in an S-shape around the clitoris. Another possible visual prompt may be changing the color of the particular location on the screen where the user is instructed to place their tongue. Other methods of displaying the instructions for the user, whether verbally, auditorially, or visually, are also possible.

In one embodiment of the invention, a software timer is used to keep track of the amount of time the user is engaged in simulated cunnilingus. The timer then prompts the auditory instructions. According to current knowledge in the field of human sexuality, brief pauses in stimulation—5 seconds or so, or 10 seconds during the final stage—can lead to more intense and satisfying orgasms. When a woman reaches a plateau during sex, such a pause can take her past the plateau. The tutorial instructions in the program can help teach the user to understand the signals the woman is giving her partner with her body language, clitoral erection feedback, and auditory feedback, and to adjust the timing patterns of their tongue's activity to her response. For example, the tutorial instruction can be “she is plateauing now, stop massaging her clitoris with your tongue, and only lightly touch her clitoris with your tongue while counting to 5 seconds; now resume, licking her clitoris in the pattern she likes the most.” Then, later in the training session, the software tutorial can say “Notice how she is squirming; her clitoris is hard, now she is nearing orgasm; now she has plateaued again, stop massaging her clitoris with your tongue and only lightly touch it, and count out 10 seconds; now gently place your finger in her vagina and begin licking her clitoris in the pattern she likes the most with extra intensity; do not stop until she has an orgasm.”

The tutorial program could also tell the user to briefly stop giving cunnilingus and instruct him or her to say “Hmmm I love the way you taste!”

The system can also provide the user with an audio recording of a fantasy 330 to encourage sexual excitement and to make the experience more interesting. Such fantasies may be customized by the user (inserting a name, changing the type of situation depicted, and so on). In an alternate embodiment of the invention, a visual image may also be displayed on a second display, depicting a female reacting to the sexual stimulation performed by the user.

Finally, the system can also evaluate the user's performance 340. The evaluation may simply be in the form of the loudness and intensity of the simulated orgasm, or it can take other forms such as numerical scores, a graphical indication of “tongue MPH” or “orgasms per hour”, or a separate physical device such as an arcade-game machine that provides a graphical or audible indication of “orgasmic strength” or other similar feedback on the user's performance.

The software can interface with social networks and sexuality blogs where program users could post their own tutorial instruction ideas for patterns of cunnilingus to be used as training tutorials on the device.

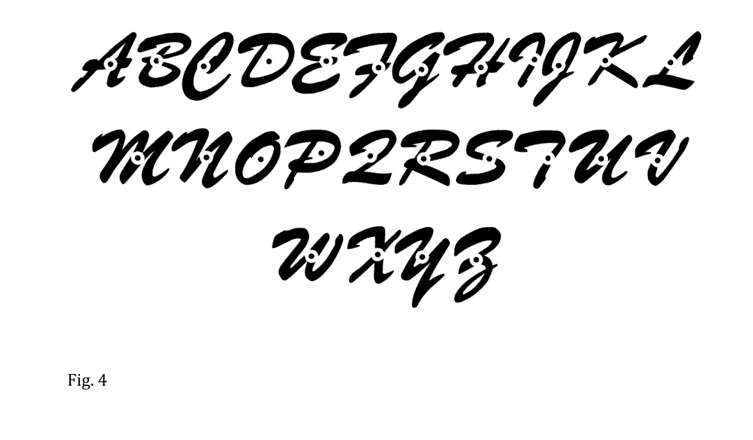

FIG. 4 shows one possible set of instructional patterns, involving “clitoral calligraphy”. In this set of patterns, the letters of the alphabet are displayed on the screen, overlaid on top of the image of the female genitalia and centered on the clitoris, so that the user can trace those letters with his or her tongue. The letters may be chosen randomly, may be in alphabetical order, or may spell out a particular woman's name. Other patterns, instructional sets, or sexual fantasies may be generated by the user, saved, and uploaded to a social network or a website to be shared with other users.

The verbal prompts and auditory feedback can be provided via stereo headphones for greater privacy. In one embodiment of the invention, the left channel of the stereo sound is used to provide verbal prompts, the right channel is used to provide auditory feedback, and both channels can also provide background music.

The touchscreen device can be a smartphone, a tablet, or a separate touchscreen controller for a computer, arcade game machine, or other device. Any touchscreen technology can be used, as long as the device can respond to tongue contact.

The user can input female names or other information into the program to personalize the prompts, description of fantasies, or instructions. For example, the user can be directed to “think about Rachel” while moving their tongue in an R pattern around the clitoris.

Since every woman is different, the system may also be customizable by the user, the user's partner, or a third party such as a sex therapist. For example, a woman may be able to set the most “sensitive” spots on the app to match her most sensitive spots, to set the speed and intensity of her preferred stimulation, to select tongue movement patterns that she especially likes, and to save it all to the device's memory so that her partner may practice his or her oral sex skills in a way that would most please her.

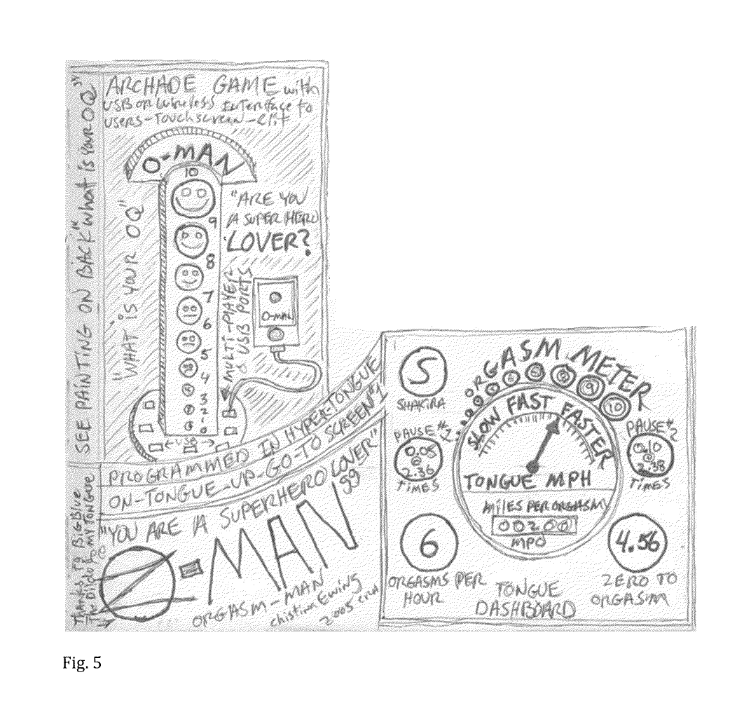

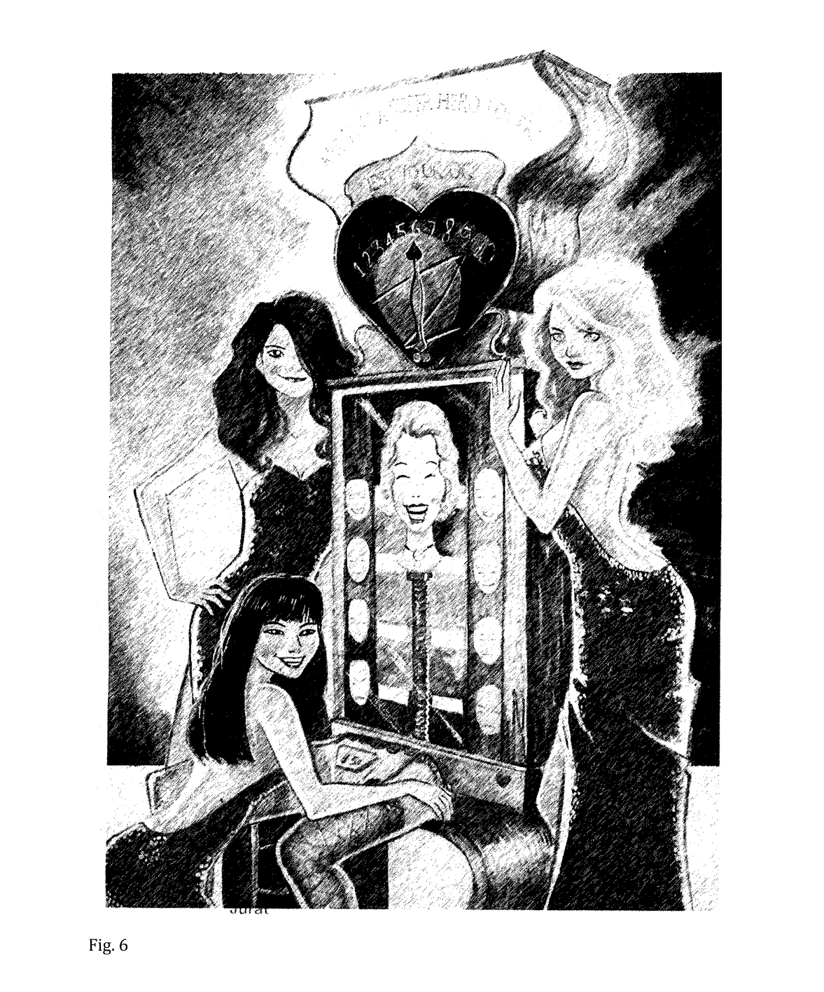

An alternate embodiment of the invention comprises an arcade game with a touchscreen interface, as shown in FIGS. 5 and 6. The game can be a single player or a multiple player game. The touchscreen interface can be part of the game console, or a user can plug in their own smartphone as the game interface. The arcade game can have a display that indicates the strength of the simulated “orgasm”, the points the user accumulates during the game, or any other information. The users may compete with each other directly, as in a two- or more-player game, or may use the device in turn and see who gets more points. In an embodiment of the invention, two or more scoreboards, or two or more images of women, may be displayed on the screen side by side, so that the players get a visual indication of how they are performing and who is doing better.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

1. A system for simulating cunnilingus, comprising:
a device comprising a touchscreen, a processor, and a memory;
a conductive overlay adhered to the touchscreen, said conductive overlay comprising at least one tactile element that can be perceived by the human tongue;
the memory comprising instructions that, when executed by the processor, provide an image of the female genitalia on the touchscreen, and provide a response when the touchscreen is touched.

2. The system of claim 1, where the response simulates the female sexual response.

3. The system of claim 1, where the memory further comprises instructions that, when executed by the processor, provide the user with guidance on how to perform cunnilingus, said guidance being one or more of a group that comprises auditory guidance and visual guidance.

4. The system of claim 3, where the guidance is ongoing and responsive to the user's actions.

5. The system of claim 1, where the device is a smartphone.

6. The system of claim 1, where the conductive overlay is shaped like the female genitalia.

7. The system of claim 1, where the conductive overlay is flat with a single bump at the location of the clitoris.

8. The system of claim 1, where the conductive overlay is made of polyethylene terephtalate.

9. The system of claim 1, where the conductive overlay covers only part of the touchscreen.

10. The system of claim 1, further comprising:
a second device, comprising a screen and a communication interface for communication with the device, said second device displaying an image that reacts to the user's touching of the touchscreen of the device.

11. The system of claim 10, where the second device also displays a rating of the user's performance.

12. The system of claim 10, where the second device also displays visual instructions to the user.

13. The system of claim 10, where the second device is an arcade game console.

14. The system of claim 10, where the second device is capable of communication with multiple mobile devices operated by multiple users simultaneously.

15. The system of claim 14, where the second device shows a rating of each user's performance.

16. A method of teaching oral sex skills, comprising:
providing a device, said device comprising a touchscreen, a processor, and a memory;
mounting a conductive overlay on the touchscreen, said conductive overlay comprising at least one tactile element that can be perceived by the human tongue;
displaying an image of the female genitalia on the touchscreen;
providing a response to the user when the user's tongue touches the touchscreen.

17. The method of claim 16, where the response to the user is real-time feedback on the user's actions.

18. The method of claim 16, where the response can be customized.

19. The method of claim 16, further comprising providing guidance to the user.

20. The method of claim 19, where the guidance is ongoing and responsive to the user's actions.

21. The method of claim 16, further comprising rating the user's performance.

22. The method of claim 16, where the response is provided on a second device, said second device comprising a display and a communication interface to the first device.

23. The method of claim 19, where the guidance can be customized.

24. The method of claim 23, where the customized guidance can be saved.
